(19) United States
(12) Patent Application Publication
(10) Pub. No.: US 2025/0098689 A1
(43) Pub. Date: Mar. 27, 2025

(54) POULTRY HANGING SYSTEM, POULTRY CONVEYING LINE, AND METHOD OF HANGING THE POULTRY

(71) Applicant: Meyn Food Processing Technology B.V., OOSTZAAN (NL)

(72) Inventors: Rick Sebastiaan van Stralen, Oostzaan (NL); Aloysius Christianus Maria van Steijn, Oostzaan (NL); Gertjan Al, Oostzaan (NL); René Franke, Oostzaan (NL)

(21) Appl. No.: 18/889,806

(22) Filed: Sep. 19, 2024

(30) Foreign Application Priority Data
Sep. 21, 2023 (NL) 2035845

(51) Int. Cl. A22C 21/00

(52) U.S. Cl. CPC A22C 21/0053

(57) ABSTRACT

A poultry hanging system for feeding a primary line in which the poultry is or will be suspended from first carriers that are movable at a first conveying speed. A poultry feedline transfers non-suspended poultry to at least one secondary line wherein transfer units may be provided for transferring the poultry from the at least one secondary line to the primary line. The at least one secondary line can be equipped with second carriers for suspending the poultry. The poultry feedline transfers the non-suspended poultry to a suspension location where the poultry is suspended in the second carriers of the at least one secondary line At least in the suspension location the second carriers of the at least one secondary line are movable at a second conveying speed lower than the first conveying speed.

### PRIORITY STATEMENT

The present application claims priority under 35 U.S.C § 119 to Dutch Patent Application No. 2035845, filed on Sep. 21, 2023.

### FIELD OF THE INVENTION

In general, the present disclosure relates to a poultry hanging system, poultry conveying line, and method of hanging poultry.

### BACKGROUND OF THE INVENTION

A poultry hanging system is known from U.S. Publication No. 2013/0052924, which indicates a method and apparatus for suspending living or stunned poultry to be slaughtered in conveyor brackets of an overhead conveyor. A belt conveyor delivers the poultry to a distribution surface, where the poultry are successively guided or pushed outwardly against an edge of the distribution surface to individual positions for receiving the poultry with the legs projecting from the edge of the positions. The legs are fixed in fixing means at the positions. The individual positions are then successively moved upwardly relative to the distribution surface to suspend the poultry for a subsequent downward movement of the positions by brackets of the overhead conveyor running above and spaced apart from the distribution surface. The positions are subsequently moved downwardly again to the level of the distribution surface.

Although this known poultry hanging system provides a more secure and gentle suspending of poultry, it is observed that this secure suspending of the poultry requires a secure positioning of the legs of the poultry over the edge of the distribution surface in order to enable a lifting device as disclosed in FIGS. 1 through 7 of US2013/0052924 so as to pick up and lift off the poultry from the distribution surface. This means that the accuracy of the hanging system depends on both the accuracy of the operators work in positioning the poultry legs accurately over the edge of the distribution surface but also on the accuracy in the dimensioning and operation of the lifting device, which is designed with an assumption on where and how far the poultry legs extend over the edge of the distribution surface. All in all, this is rather complicated and prone to misalignment at several instances.

The above problems are intensified by the fact that the pace of working of the operators is dictated by the conveying speed of the first carriers in the primary line. Particularly at the nowadays conventional conveying speeds which may amount to 15000 chickens per hour at a pitch of 15 cm/6 inch, the work of the operators is stressful and hanging efficiency is at stake at such high line speeds.

Accordingly, there is room for a more simple solution and improvement over the prior art.

### BRIEF DESCRIPTION OF THE INVENTION

Aspects and advantages of the invention will be set forth in part in the following description, or may be obvious from the description, or may be learned through practice of the invention.

In one exemplary aspect, an object of the present invention is to provide for simplification and improvement, wherein particularly the working conditions for the operators are improved.

In summary, exemplary aspects of the invention relate to a poultry hanging system for feeding a primary line in which the poultry is or will be suspended from first carriers that are movable at a first conveying speed. A poultry feedline may be included for transferring non-suspended poultry to at least one secondary line, wherein transfer units are provided for transferring the poultry from the at least one secondary line to the primary line. The transfer units may be of any available design that is known from the prior art. A poultry hanging system, a poultry conveying line that may be used in such a poultry hanging system, and a method for hanging the poultry are proposed having the features according to one or more of the appended claims.

In a first exemplary aspect of the invention, the at least one secondary line may be equipped with second carriers for suspending the poultry. In use, the poultry feedline transfers the non-suspended poultry to a suspension location where the poultry is suspended in the second carriers of the at least one secondary line. At least in the suspension location, the second carriers of the at least one secondary line are movable at a second conveying speed that is lower than the first conveying speed of the primary line.

In an exemplary aspect of the invention, a benefit can be achieved that the operation can be carried out in a manner that is attuned to the second conveying speed of the at least one secondary line, which may be half or even lower than the first conveying speed of the primary line—while avoiding that more operators are required or more stress is experienced in the execution of the task of hanging the poultry. In another exemplary aspect, a further benefit of the invention may be that the required accuracy in the operation of the system concentrates to the suspension locations where the poultry will be suspended in the carriers of the at least one secondary line. Overall the entire poultry hanging operation can then be carried out more securely and reliably, and with simpler means.

As indicated in the exemplary aspects above, the suspension locations may be equipped with one of an operator position, but it is also envisaged that the hanging can be done with automatic hanging equipment, which can be any type of automatic hanging equipment known in the art. Such suitable automatic hanging equipment is, for example, disclosed in European patent application EP 23162287.9 and in European patent application EP 23164542.5, both in the name of the applicant.

In another exemplary aspect, it may be beneficial that the system is provided with two or more secondary lines. When more secondary lines are provided their individual conveying speeds can be further lowered without compromising the conveying speed of the primary line.

In another exemplary aspect, it is envisaged that a first distance or pitch between the carriers in the primary line may be variable, but preferably the distance between carriers in the primary line is constant.

Advantageously, for the exemplary embodiments described herein, the second carriers in the secondary line are at a second distance in the suspension location and at a third distance near the transfer units, wherein the third distance is larger than the second distance. This enables that operational conditions at the suspension location and the operational conditions near the transfer units can be optimized for the functions of suspending the poultry and transferring the poultry, respectively.

To support a reliable operation it is further preferable in certain exemplary embodiments that the transfer units are synchronized with the primary line to arrange that poultry suspended in the second carriers of the at least one secondary line are all individually transferred to an available empty first carrier in the primary line. As will be understood by those of skill in the art, this can be done by, for example:
1) a mechanical coupling between the primary line and the secondary line(s), or
2) an electronic controlled coupling (electronic gear) between the primary line and the secondary line(s), making use of sensors and encoders (pulse generators), electric drives and a control system.

The features as discussed in this paragraph can be applied separate from the other features as discussed herein and independent therefrom. The construction of the or each secondary line may be according to different embodiments as known from the prior art, provided that any such secondary line is equipped with carriers for suspending the poultry. It is, however, preferable in certain exemplary embodiments that the one or more secondary lines include an endless pathway for the second carriers, wherein rotation wheels drive the second carriers along at least a part of the pathway, and wherein one or more predominantly straight sections of the pathway are provided between the rotation wheels, and that the or each secondary line is provided with a spindle drive for driving the second carriers in the straight sections between the rotation wheels. The spindle drive secures an accurate way of driving the carriers at a specific speed which is dedicated to the hanging operation on the poultry in the straight sections, which embody the suspension locations where the poultry is suspended in the at least one secondary line.

In an exemplary aspect of the invention, suitably each of the carriers may be provided with a protrusion or protrusions that extend to and cooperate with at least one of the spindle drive and the rotation wheels.

In another exemplary aspect, it is further preferable that the rotation wheels drive the second carriers in the at least one secondary line independent from the spindle drive for the second carriers in the at least one secondary line. This is particularly beneficial for optimizing and differentiate between the speeds applied in the at least one secondary line at suspending the poultry, and at rehanging the poultry from the at least one secondary line to the primary line. In connection therewith it is to be noted that preferably the transfer units are located at the at least one secondary line opposite to the rotation wheels.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

The accompanying drawings, which are incorporated into and forms a part of the specification, illustrates one or more embodiments of the present invention and, together with the description, serves to explain the principles of the invention. The figures are only for the purpose of illustrating one or more embodiments of the invention and are not to be construed as limiting the invention.

In the drawings:

FIG. 1 schematically shows a first exemplary embodiment of a poultry hanging system of the invention;

FIG. 2 schematically shows a second exemplary embodiment of a poultry hanging system of the invention; and

FIG. 3 shows an exemplary poultry conveying line according to the invention.

Whenever in the figures the same reference numerals are applied, these numerals refer to the same or similar parts.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

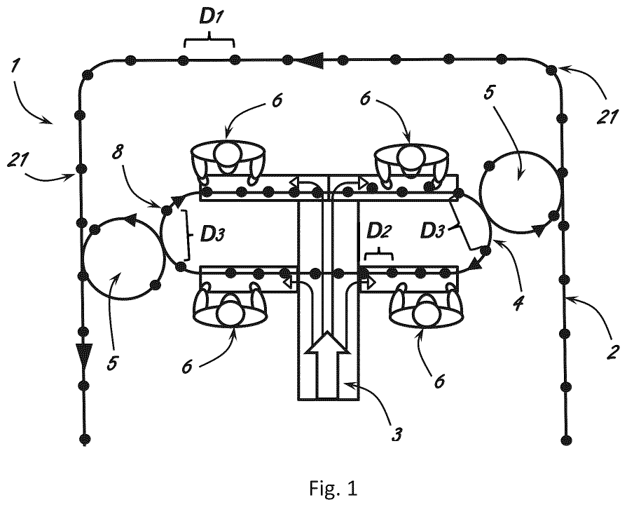

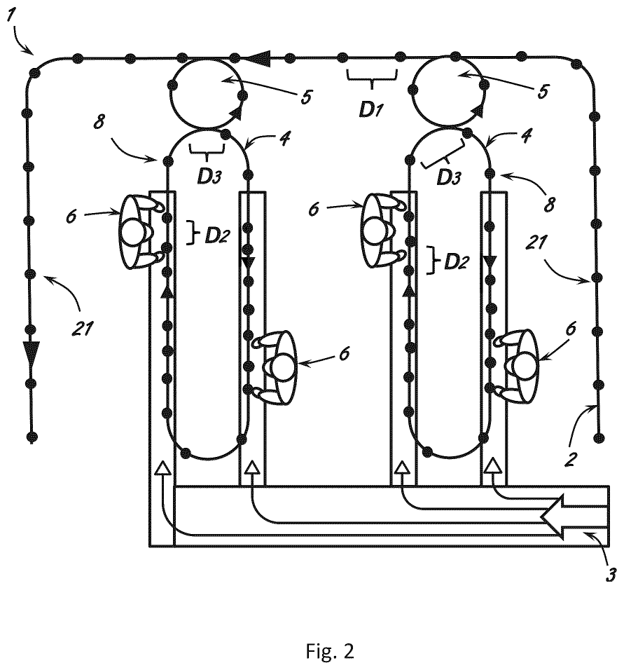

FIG. 1 and FIG. 2 depict two different exemplary embodiments of a poultry hanging system 1 according to the invention. Such a poultry hanging system 1 is used for feeding a primary line 2 that runs at high speed and in which the poultry is or will be suspended from first carriers 21, e.g., suspended from the feet or from the head. The primary line 2 transfers the suspended poultry subsequently to certain process equipment where the poultry will be subjected to further processing. Because of the high-speed it is a challenge to occupy each and every separate first carrier 21 of the primary line 2 with suspended poultry and avoid that carriers remain empty.

The poultry that is to be suspended in the primary line 2 is supplied with a conveyor line or poultry feedline 3. In poultry feedline 3, the poultry may be without any particular orientation and may be transported in crates or freely. In order to meet the requirement that every separate first carrier 21 in the primary line 2 may receive suspended poultry, use is made of at least one secondary line 4 with second carriers 8 that are movable at a second conveying speed, and wherein the second conveying speed is lower than the first conveying speed of the first carriers 21 in the primary line 2.

FIG. 1 depicts the situation that there is only a single secondary line 4, whereas FIG. 2 depicts the situation that there are two secondary lines 4. The number of secondary lines 4 can be further increased if the need arises.

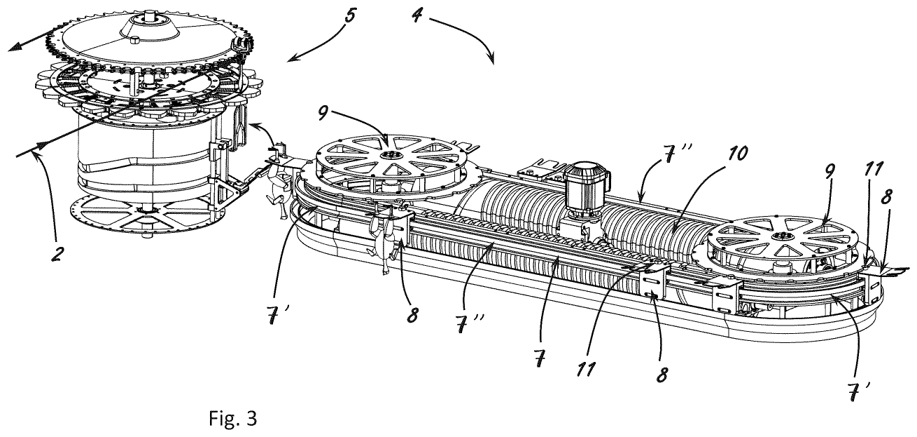

In both FIG. 1 and FIG. 2 it is shown that transfer units 5 are provided for transferring the poultry from the one or more secondary lines 4 to the primary line 2. Specific to the invention is that the one or more secondary lines 4 (depending up on the embodiment) are equipped with second carriers for suspending the poultry (e.g. from the feet or from the head). Exemplary second carriers, like the exemplary first carriers 21 of the primary line 2, are known per se. Second carriers 8 of the at least one secondary line 4 are schematically shown in FIG. 3.

As is shown in both FIG. 1 and FIG. 2 the poultry feedline 3 transfers the non-suspended poultry to a suspension location, where operators 6 are positioned that take the poultry from the conveyor line 3 and suspend the poultry in the second carriers of the one or more secondary lines 4. Although FIG. 1 and FIG. 2 only show operators 6, the task of taking the poultry from the conveyor line 3 and suspend the poultry in the second carriers of the secondary line 4 can also be done by robots, or by a combination of human operators and robots. Accordingly the suspension location is equipped with at least one of a workplace for an operator and an automatic hanging equipment, preferably in the form of robots with visual and handling capabilities.

Although it is possible that the distance between the carriers in the primary line 2 is variable, it is preferred for its simplicity that a first distance D1 between the first carriers 21 in the primary line 2 is constant.

On the other hand, although it is possible that the distance of the second carriers in the secondary line 4 is unitary, it is preferred that the second carriers in the secondary line 4 are at a second distance D2 in the suspension locations and at a third distance D3 near the transfer units 5, wherein the third distance D3 is larger than the second distance D2. The distances of the carriers in the secondary line 4 can thus be attuned to the suspension operation and to the transfer operation.

It is further beneficial that the transfer units 5 are synchronized with the primary line 2 to arrange that poultry suspended in the second carriers of the at least one secondary line 4 are all individually transferred to an available empty first carrier 21 in the primary line 2.

With reference to FIG. 3 a preferred embodiment is shown of the secondary conveyor line 4. For this exemplary embodiment, FIG. 3 shows that the secondary line 4 (only one is shown but more than one secondary line 4 may be included as stated above) include an endless pathway 7 for the carriers 8, wherein rotation wheels 9 drive the second carriers 8 along at least a part 7′ of the pathway 7, and wherein one or more predominantly straight sections 7″ of the pathway 7 are provided between the rotation wheels 9.

FIG. 3 shows that the secondary line 4 is provided with a spindle drive 10 for driving the second carriers 8 in the straight sections 7″ between the rotation wheels 9. It also shows that the transfer units 5 are located at the at least one secondary line 4 opposite to the rotation wheels 9, which is an optimal location in this exemplary embodiment for executing the rehanging of the poultry from the at least one secondary line 4 to the primary line 2. In a (not shown) embodiment the rotation wheels 9 may be combined with the transfer units 5.

FIG. 3 further depicts each of the second carriers 8 is provided with a protrusion 11 that extends to and cooperates with the spindle drive 10. This same protrusion or another protrusion may be applied to extend to and cooperate with the rotation wheels 9.

It is further remarked that the rotation wheels 9 drive the second carriers 8 in the at least one secondary line 4 independent from the spindle drive 10 for the second carriers in the at least one secondary line 4.

Embodiments of the present invention can include every combination of features that are disclosed herein independently from each other. Although the invention has been discussed in the foregoing with reference to an exemplary embodiment of the invention, the invention is not restricted to this particular embodiment which can be varied in many ways without departing from the invention. The discussed exemplary embodiment shall therefore not be used to construe the append-ed claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

1-15. (canceled)

16. A poultry hanging system for feeding a primary line in which the poultry is or will be suspended from first carriers that are movable at a first conveying speed, comprising:
a poultry feedline for transferring non-suspended poultry to at least one secondary line, including transfer units for transferring the poultry from the at least one secondary line to the primary line;
wherein the at least one secondary line is equipped with second carriers for suspending the poultry, the poultry feedline configured for transferring the non-suspended poultry to a suspension location where the poultry is suspendable in the second carriers of the at least one secondary line, wherein at least in the suspension locations the second carriers of the at least one secondary line are movable at a second conveying speed that is lower than the first conveying speed of the primary line.

17. The poultry hanging system of claim 16, wherein the suspension location is equipped with one of either a workplace for an operator or automatic hanging equipment.

18. The poultry hanging system of claim 16, wherein the system comprises two or more secondary lines.

19. The poultry hanging system of claim 16, wherein a first distance between first carriers in the primary line is constant.

20. The poultry hanging system of claim 19, wherein the second carriers in the least one secondary line are at a second distance in the suspension locations and at a third distance near the transfer units, wherein the third distance is larger than the second distance.

21. The poultry hanging system of claim 16, wherein the transfer units are synchronized with the primary line to arrange that poultry suspended in the second carriers of the at least one secondary line are all individually transferred to an available empty first carrier in the primary line.

22. The poultry hanging system of claim 16, wherein the at least one secondary line comprises:
an endless pathway for the second carriers;
rotation wheels that drive the second carriers along at least a part of the pathway; and
wherein one or more predominantly straight sections of the pathway are provided between the rotation wheels, and that the at least one secondary line is provided with a spindle drive for driving the second carriers in the straight sections between the rotation wheels.

23. The hanging system of claim 22, wherein the suspension location is at one or more predominantly straight sections of the pathway.

24. The poultry hanging system of claim 22, wherein each of the carriers is provided with a protrusion or protrusions that extend to and cooperate with at least one of the spindle drive and the rotation wheels.

25. The poultry hanging system of claim 22, wherein the rotation wheels drive the second carriers in the at least one secondary line independent from the spindle drive for the second carriers in the at least one secondary line.

26. The poultry hanging system of claim 25, wherein the transfer units are located at the at least one secondary line opposite to the rotation wheels.

27. A poultry conveying line, comprising:
an endless pathway for carriers for suspending poultry,
rotation wheels that drive the carriers along at least a part of the pathway, wherein one or more predominantly straight sections of the pathway are provided between the rotation wheels; and
a spindle drive for driving the carriers in the straight sections between the rotation wheels.

28. The poultry conveying line of claim 27, wherein each of the carriers is provided with a protrusion or protrusions that extend to and cooperate with at least one of the spindle drive and the rotation wheels.

29. The poultry conveying line of claim 27, wherein the rotation wheels drive the carriers independent from the spindle drive for driving the carriers in the straight sections between the rotation wheels.

30. A method for feeding a primary line in which poultry is or will be suspended from first carriers that are movable at a first conveying speed, comprising:
transferring non-suspended poultry to at least one secondary line;
transferring the poultry from the at least one secondary line to the primary line;
transferring the non-suspended poultry to a suspension location where the poultry is suspended in second carriers of the at least one secondary line, wherein at least in the suspension location the second carriers of the at least one secondary line are moved at a second conveying speed that is lower than the first conveying speed of the primary line.
